(19) United States
(12) Patent Application Publication
(10) Pub. No.: US 2023/0001309 A1
(43) Pub. Date: Jan. 5, 2023

(54) CROSS SKILL COMPETITION

(71) Applicant: SONY INTERACTIVE ENTERTAINMENT LLC, San Mateo, CA (US)

(72) Inventor: Mark Villa, San Mateo, CA (US)

(21) Appl. No.: 17/365,744

(22) Filed: Jul. 1, 2021

(51) Int. Cl. A63F 13/798; A63F 13/847; A63F 13/46

(52) U.S. Cl. CPC A63F 13/798; A63F 13/847; A63F 13/46

(57) ABSTRACT

A plurality of game titles may be hosted on a gaming network platform. Real-time gameplay data involving the plurality of game titles may be tracked. A skill profile from one or more player devices associated with one or more players may be received by a competition server. A subset of players may be invited to join a house, neighborhood, and village. One or more scores may be received from the players in the village. The scores may be aggregated at the end of a predetermined time period.

### BACKGROUND OF THE DISCLOSURE

### 1. Field of the Disclosure

The present disclosure generally relates to interactive game play. More specifically, the present disclosure relates to game play across various skills and competitions.

### 2. Description of the Related Art

Many games are network or community-based with multiple players located around the country or around the world. Such games may involve the multiple players playing competitively and/or cooperatively in teams amongst each other. While the ability to interact and compete with so many other players may increase user enjoyment and challenges, certain complexities in dealing with so many players inevitably arise. One example may involve evaluating players and their game play at the same and/or disparate games.

Holding a competition may involve skills evaluation. Competitions are more competitive and therefore successful, for example, when disparities in skill level are not too great. Expert players may find it boring to play inexperienced players, while the inexperienced players may find it demoralizing to play expert players. Further, such games as played between players of wide disparate skill level are often short and have predictable outcomes, leading spectators to be bored as well.

### SUMMARY OF THE DISCLOSURE

Aspects of the present disclosure include systems and methods for cross skill competition. A game network server hosts a plurality of game titles and tracks real-time gameplay data involving the plurality of game titles. A competition server receives a skill profile that includes one or more supported skills from one or more player devices associated with one or more players. The competition server may then invite a subset of the players with a same skill profile to join a house. The competition server may then invite the subset of the players in the house to a neighborhood that includes one or more houses with unique skill sets. The competition server may further invite the subset of the players in the neighborhood to a village that competes against other villages with a same skill set. The competition server may receive one or more scores for each of the players in the village and aggregate the scores for each of the players in the village at the end of a predetermined time period.

In one aspect, a cross skill competition system is contemplated whereby the system includes at least one game network server that hosts a plurality of game titles and tracks real-time gameplay data involving the plurality of game titles. The cross skill competition system includes at least one competition server. The competition server receives a skill profile from one of more player devices associated with one or more players, wherein the skill profile includes one or more supported skills. The competition server invites a subset of the players with a same skill profile to join a house. Next, the competition server invites the subset of players in the house to a neighborhood, wherein the neighborhood includes one or more houses with unique skill sets. Additionally, the competition server invites the subset of the players in the neighborhood to join a village, wherein the village competes against other villages with a same skill set. The competition server receives one or more scores for each of the players in the village and aggregates the scores for each of the players in the village at the end of a predetermined time period.

In another aspect, the system may include a competition server which further displays the aggregate scores, via an interface associated with the player devices. In another aspect, the competition server may display the aggregate scores on a daily, weekly, or monthly basis. In a further aspect, the system may include a competition server wherein the competition server further receives a request from a player in the village to be a mayor of the village. In an additional aspect, the system may include a mayor who may request a minimum skill level for the village. In another aspect, the system may include a skill profile which includes a motto. In a further aspect, the system may include a charity in the skill profile. In another aspect, the competition server within the system may receiver a request from a second subset of players and allow the second subset of players to track a progress level of the neighborhood. In a further aspect, the system may include a neighborhood having a predefined number of houses.

In another aspect, a method for cross skill competition is contemplated. The method hosts a plurality of game titles, tracks real-time gameplay data involving the plurality of game titles, and receives a skill profile from one or more player devices associated with one or more players wherein the skill profile includes one or more supported skills. Further, the method invites a subset of players with a same skill profile to join a house, invites the subset of players in the house to a neighborhood wherein the neighborhood includes one or more houses with unique skill sets, and invites the subset of players in the neighborhood to a village wherein the village competes against other villages with a same skill set. Further, the method receives one or more scores for each of the players in the village and aggregates the scores for each of the players in the village at the end of a predetermined time period.

In another aspect, the method may include displaying the aggregate scores via an interface associated with the player devices. In a further aspect, the aggregate scores may be displayed on a daily, weekly, or monthly basis. In an additional aspect, the method may include receiving a request from a player in the village to be a mayor of the village. In another aspect, the mayor may request a minimum skill level for the village. In a further aspect, the skill profile may include a motto. In an additional aspect, the skill profile may include a charity. In another aspect, the method may receive a request from a second subset of players and allow the second subset of players to track a progress level of the neighborhood. In a further aspect, the method may include a neighborhood having a predefined number of houses.

In another aspect, a non-transitory computer-readable storage medium is contemplated. The non-transitory computer-readable storage medium having embodied thereon a program executable by a processor to perform a method for cross skill competition. The method including hosting a plurality of game titles, tracking real-time gameplay data involving the plurality of game titles, and receiving a skill profile from one or more player devices associated with one or more players wherein the skill profile includes one or more supported skills. Further, the method invites a subset of players with a same skill profile to join a house, invites the subset of players in the house to a neighborhood wherein the neighborhood includes one or more houses with unique skill sets, and invites the subset of players in the neighborhood to a village wherein the village competes against other villages with a same skill set. Further, the method receives one or more scores for each of the players in the village and aggregates the scores for each of the players in the village at the end of a predetermined time period.

### BRIEF DESCRIPTION OF THE DRAWINGS

FIG. 1 an exemplary network environment in which systems for cross skill competition may be implemented.

FIG. 2 an exemplary competition server for cross skill competition.

FIG. 3 is a flowchart illustrating an exemplary method for cross skill competition.

FIG. 4 is a block diagram of an exemplary computing device that may be used to implement an aspect of the system of FIG. 1.

FIG. 5 is a diagram illustrating the structure of the house, neighborhood, and village.

### DETAILED DESCRIPTION

Competitors in sports compete in matches and even tournaments of several matches. These matches and tournaments may take place within in-game environments and may be associated with in-person events similar to live sporting events and other activities that engage a fan base. There is presently a wide variety of games played in a variety of different modes. Some games are played head-to-head against one or more player, while others are played in teams, which may or may not be against another team.

The present disclosure describes methods and systems for cross skill competition. One or more players engage in one or more sports or video games. Each player's progress is monitored and/or ranked and updated on a regular basis. Players are organized into houses, neighborhoods, and villages. Players in each village have their score combined and compete against other villages.

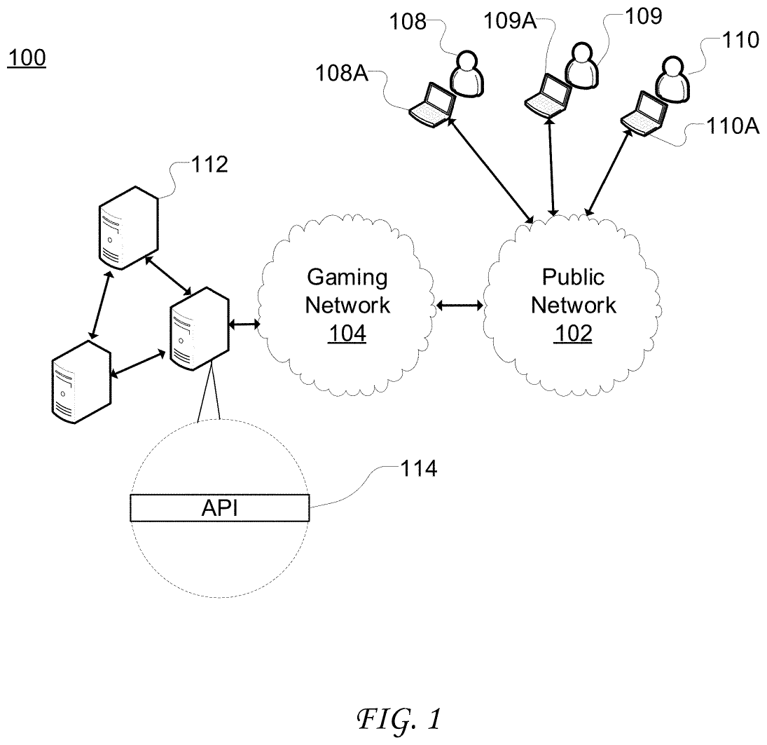

FIG. 1 illustrates an exemplary network environment 100 in which a system for cross skill competition may be implemented. Network environment 100 includes public network 102, which can include one or more private networks, such as, a local area network (LAN), a wide area network (WAN), or a network of public/private networks, such as the Internet. The Internet is a broad network of interconnected computers and servers allowing for the transmission and exchange of Internet Protocol (IP) data between user devices connected through a network service provider. Examples of network service providers are the public switched telephone network, a cable service provider, a provider of digital subscriber line (DSL) services, or a satellite service provider. Public network 102 allows for communication between the various components of network environment 100. Public network 102 is communicatively coupled to gaming network 104, which may further provide a network of computing resources.

Gaming network 104 may be any collection of one or more servers configured to host and support one or more game titles accessible over public network 102. A gaming network server of gaming network 104 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

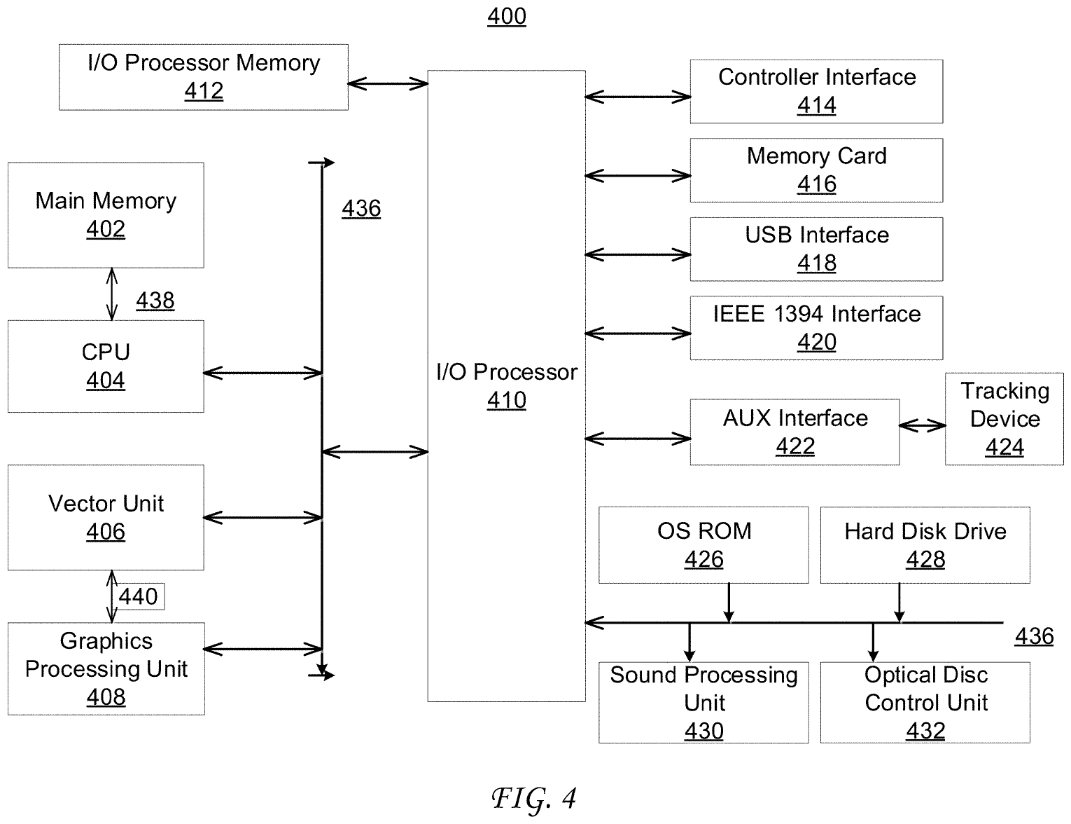

As illustrated in FIG. 1, players 108, 109, and 110 are permitted access to one or more competition servers 112 using respective client devices (e.g., 108A, 109A, and 110A). As used herein, players 108-110 may be inclusive of spectators (and commentators) that may access a gameplay session or stream for the purpose of viewing rather than participation. Although client devices 108A, 109A, and 110A, are depicted as game console devices, it is understood that the client devices can include various types of processor-based systems, including but not limited to: personal computing devices, smartphones, tablets, other portable gaming devices, and the like. Such client devices 108A-110A may also be configured to access data from other storage media, such as memory cards or disk drives as may be appropriate in the case of downloaded services. Client devices 108A-110A may include standard hardware computing components such as network and media interfaces, non-transitory computer-readable storage (memory), and processors for executing instructions that may be stored in memory. Example of hardware systems that can be used to implement the client device are discussed in further detail below with respect to FIG. 4.

The players 108-110 may be registered with a user account associated with gaming network 104. Such user accounts may allow the user to access and play a variety of media titles on the gaming network platform. Gaming network 104 may further provide its registered users with options for verified accounts (e.g., for professional, semi-pro, or other celebrity users), team management, community tools, events tracking, social tools (e.g., friends lists), following other accounts, instant messaging, browsing live and archived streams, and other features related to playing or spectating games on the platform.

The competition server 112 may engage in team building and/or team management. The players 108-110, in response to reporting a skill profile may be matched with other players or teams based on reported skill levels or abilities. Matching may occur with an aim toward matching similarly skilled players in head-to-head competition. Matching may occur with respect to creating virtual groups or “houses” whereby players' skills are complimentary to one another.

Gaming network 104 may be integrated with competition server 112 so as to allow for automatic communication of gameplay data and/or gameplay statistics. The gameplay data can be received by competition server 112, for example, using an application programming interface (API), such as API 114. Depending on implementation, gameplay data can be collected via active monitoring of an online game environment, or received from one or more external systems, for example, as part of a game performance data set that includes information describing individual player performance for one or more game titles and/or genre categories.

Competition server 112 may create and support competitions between various players 108 (or teams of players) and for various game titles. Players who register may be ranked during predetermined time periods, and such rankings may be used to determine placement during competitions. Such rankings may carry over to a certain extent between different seasons but may also be adjusted based on certain factors (e.g., lack of activity). In some aspects, players that have played in previous seasons may enter the following season at a higher tier than brand new players. Further, the highest-ranked players may be dropped down a level so that they have room improve throughout the season.

The competition server 112 may further provide a way for players having a user account in the gaming network platform to register for competitions. Because the registering player may already have a user account, registration for competitions may involve linking or otherwise accessing the user account information for use in tournament registration, as well as for associated qualification verification, recruiting and invitations, team-building, notifications, reminders, match scheduling and check-ins, updated brackets, results verification, real-time reporting, dispute management, and broadcast/stream production. A player account may be associated with a group of friends, for example, which may be a basis for sending out invitations to participate in competitions, team-building, or organizing spectator watch parties.

A personal profile may be received for each of the one or more players. Each personal profile may include player biographical or identifying information and other non-skill specific information, such as email address. A skill profile may be received for each of the one or more players. Each skill profile may include player skill (and/or skill division), motto, logo, and/or charity for a corresponding one of the players. An example of a skill division is a skill, such as baseball, and a division such as Major League. The personal and skill profiles may be saved in a database, which may be stored, e.g., in a storage device associated with the competition server 112. Each skill profile may further associate a particular style of game play with a corresponding player based on player statistics corresponding to the player. In various aspects, the player profile of each user and/or the skill profile of each user may be stored on the competition server 112. Alternatively, the player profile, skill profile, or both may be stored at various locations and/or devices within the network 100. By way of example, and not by way of limitation, each player profile may include a style identifier related to the particular style of game play. The player profile for a given one of the one or more players may be accessed by the competition server 112 and presented to a client device of one or more different players in response to a request from the client device for information relating to the given one of the one or more players.

During gameplay, a player may accumulate various statistics, meet various benchmarks, or trigger certain events related to game play. Some statistics, benchmarks, and trigger events may be provided as scoring information. Game play information may include more than scoring information or win-loss records. Depending on the game, such information may include details on how a player fared in response to certain game events, in certain game environments, or while interacting with certain team members. Such information is generated during game play and may be communicated to competition server 112 over gaming network 104 following or during the game session.

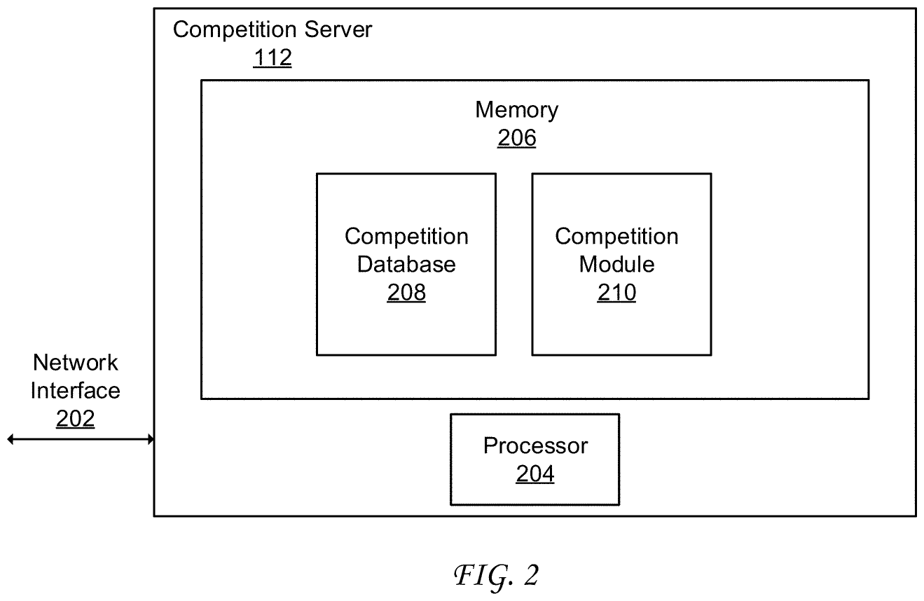

FIG. 2 an exemplary competition server for cross skill competition. Execution of competition module 210 may involve processor 204 using information stored in competition database 208 of memory 206 for various analyses. A module (or application), as referenced in the present disclosure, is inclusive of a collection of routines that perform various functions when executed. A module may be dynamically loaded and unloaded by hardware and device drivers as required. The modular software components described herein may also be incorporated as part of a larger software platform or integrated as part of an application specific component. Competition database 208 may be configured to store information concerning game play of a player during a game session. Such information may be defined by certain benchmarks or trigger events. Network interface 202 may be any of a variety of hardware and/or software components configured to allow for communication between the host and other computing devices in the network. Network interface 202 may include components for communicating over wired, wireless, and/or Internet-based communications networks. Network interface 202 further allows for competition server 112 to communicate with the others over network 100. Network interface 202 may include, for example, a Network Interface Card (NIC) or a modem that permits communications over a variety of networks.

Game play information may be generated at the client devices 108A-110A (in FIG. 1) and provided over network interface 202 to competition database 208. Competition database 208 may further include information from multiple players over multiple game sessions. In some aspects, competition database 208 allow for indexing of such information so that particular information may be easily and quickly identified and retrieved by processor 204 for subsequent analysis and/or reporting. Retrieval of information from competition database 208 by processor 204 may occur in response to a request, automatically, or at periodic intervals. Processor 204 may also execute competition module 210 in an effort to engage in team-building and/or team management. A player, in response to reporting metrics generated by execution of the competition module 210 and/or retrieved from competition database 208, may be matched with other players or teams based on reported skill levels or abilities. Matching may occur with an aim toward matching similarly skilled players in head-to-head competition. Alternatively, matching may occur with respect to creating teams or clans whereby players' skills are complimentary to one another. Execution of the competition module 210 may likewise include routines for allowing players to communicate with one another, and determine if a team should be created. In this regard, certain chat and/or messaging capabilities may be built into the module or some other aspect of the system. Certain fees may be incurred to utilize the matching capabilities of the system.

The competition server 112 includes a memory 206. The competition server 112 includes a competition database 208 that may store information regarding one or more players, including personal profiles and skill profiles corresponding to each player. The competition database 208 may maintain a list of supported skills. The competition database 208 may also store the game play information associated with each user. The competition database 208 may receive and store data concerning game play. Competition database 208 may reside on competition server 112, as illustrated in FIG. 2, or be housed separately including by a third-party or even the party generating game play data. In the instance that the competition server 112 does not store the information, game information received by the competition server 112 may be provided to one or more remote competition databases 208 for storage.

The competition module 210 reports metrics generated based on the game play information. The competition module 210 may be executed by processor 204 to access game play information (e.g., from competition database 208) and analyze such game play information to generate at least one metric for reporting. Some reporting metrics may be generated by competition module 210 based on the game play information concerning a player from a game session. Some metrics may be further based on game play information concerning other players from multiple game sessions. In some instances, a series of metrics (e.g., different metrics for different tasks and even from different players and/or in different games) may be analyzed collectively and/or combined to develop a more complex reporting metric reflective of various sub-sets of information.

In addition to the features discussed above, competition server 112 may further use such data from user and team accounts and profiles to track progress, update leaderboards, and schedule competitions. Conversely, information regarding each individual player's or team's progress or activities within the competition may be automatically populated to the respective player or team profile. For example, a player profile may be tagged or include some other indicator that the player is participating in a particular competition, what ranking the player is assigned, opponents (and associated rankings), real-time competition game data related to the player, etc.

Analysis of the metrics may indicate that a particular player is well versed in certain skills of game play or lacking in others. Analysis may also indicate that a particular player performs well with particular objects, weapons, or tools during the course of game play. Analysis may likewise indicate that a particular player performs well when working with other players, players with certain skills, and/or under certain game conditions.

Because the metrics that are used to evaluate player performance for a particular game can vary widely between game title and type, the ability to rank players require consideration of certain metrics. Such metrics may be converted from data generated in existing game titles or may be tracked at the platform during certain specified gameplay modes. Some legacy game titles may have their own ranking systems, which a tournament organizer may or may not rely on. A tournament organizer may elect to convert some or all of the existing ranking systems for use in tournament play. Creation of a tournament and corresponding parameters can be managed at the platform level, for example, by one or more of players 108-110. That is, individual players, player collectives, or other parties can specify the game-performance attributes desired for structuring the tournament.

Such standardization further allows for an objective comparison of skill level, which may provide a basis for rankings. Different genres of games—and different roles within each game— may involve different standards. Team-based gameplay, for example, may involve teammates with different types of skill sets (e.g., different weaponry, resources, in-game abilities, powers, etc.). As such, the game play of different team members may be evaluated in accordance with the different standards despite playing in the same game title.

For game titles that may be played in teams, a team may be associated with a team account or profile that includes such data for use by competition server 112. Such a team profile may be linked to the individual team member profiles. The competition server 112 may provide team management tools for use in scheduling and otherwise managing tournament participation by the team.

The competition server 112 may evaluate the game performance attributes, and gameplay statistics to determine a skill level for each player. Determinations of skill level can vary depending upon the specified game performance attributes, and can vary between game titles, and/or game genres. By way of example, skill level for a given player can be based on one or more of: collected points, a number of wins/losses, total game time, achieve difficulty level, and/or a number of “kills,” etc. Because game play occurs on the gaming network 104 platform, competition server 112 may obtain such results automatically and in real time, thereby by allowing for metrics generation, evaluation, and use in updating rankings, achievements designations, and leaderboards.

Different ranking systems may be available for different game titles. A competition may involve multiple game titles, for example, and as such, a ranking system may combine and/or weight different individual rankings within the game titles. An overall ranking for any combination of games played on the platform may also be available. As such, a player may distinguish themselves as a skilled player not only in one or a few game titles (or even a game family or genre), but within multiple different types of games.

Moreover, because the competition server 112 is in communication with gaming network 104, the competition server 112 may receive and analyze game data in real-time. As such, competition server 112 may detect when a match has started, when the match is particularly active or competitive, and other in-game events. For example, certain in-game events may be associated with certain game data or metrics. Use of certain weaponry, exhibition of certain character moves or maneuvers, scoring in a certain amount or pattern, etc., may be indicative of an unusual or otherwise notable in-game event. As such, screenshots or video may be captured regarding such events and published with links that can take a spectator to the stream, whether at the beginning of the match or directly to illustrated point of interest. Such links may be accessed in real-time (e.g., as the match is occurring) or in association with an archived stream. In some aspects, such links may be published on the gaming network 104 platform (e.g., landing pages, leaderboards, communities, forums, user profiles, team profiles, tournament profiles, bookmarks) or on sites associated with the player, team, developer, tournament organizer, broadcaster, or other content producer or streamer.

The competition server 112 communicates with the authority, such as game title leaderboards, of each skill's scoring system. The leaderboards is a ranking list, which displays each player's score, overall ranking, etc. A leaderboard provides an overall picture about the players who have played a game title. Such leaderboards typically comprise a list of user IDs and their score or other performance metric relating to a game or some aspect of a game. In an example, leaderboards may be provided quarterly or annually. In an example, at the end of a week, village scores are totaled and the village leaderboards are locked in. Typically, a subset of this list, such as the top N ranking users by score, is provided for display. A total score may also given for the player's performance. This may be calculated using any suitable method, and can take into account any suitable range of factors. By recording a total score in this way, the player is able to have an overall indicator of the quality of their performance. Behavioral data is collected, entered, or requested from players, and a profile of each player is created from the data.

In some aspects, players registered for a competitions can be ranked into multiple categories or tiers of skill level. For example, players may be categorized into a platinum tier for being in the top 2% of players, into a gold tier for being in the next 20% of players, into a silver tier for being in the next 28% of players, and into a bronze tier designated for the last 32%. Such tiers may further be subdivided as needed into + or − subdivisions. A player categorized as gold+ may be close to being moved into the platinum tier, for example, while a player categorized as gold− may be close to falling into the silver tier.

Designations of prizes, achievement or skill level can be provided based on the overall ranking of a player or group of players. Periodic and year-end prizes may be distributed to the players in the competitions. For example, digital badges, trophies, or medals can be provided to the top-ranked player (or player team), and published on an associated player (or team) profile. Such designations may be awarded as to a current season and remain visible in future seasons. Different designations may be provided for different game titles, different combinations of achievements, overall ratings, etc. Such designations and tier levels serve as the basis for matching competitors. Various search and sorting options may be provided (e.g., game title, ranking, stream parameters) so that players may filter through the available game streams, players, teams, tournaments, etc. to find other players of interest. A player may wish to find a similarly-skilled practice sparring partner, for example, or a teammate with complementary skills. Such spectators may choose to follow such players, for example, and request notifications, reminders, and schedules relating to matches involving the player(s) of interest. In some aspects, such designations may be made available through other outlets (e.g., stream sources) for searching and filtering based on a standardized skill evaluation system.

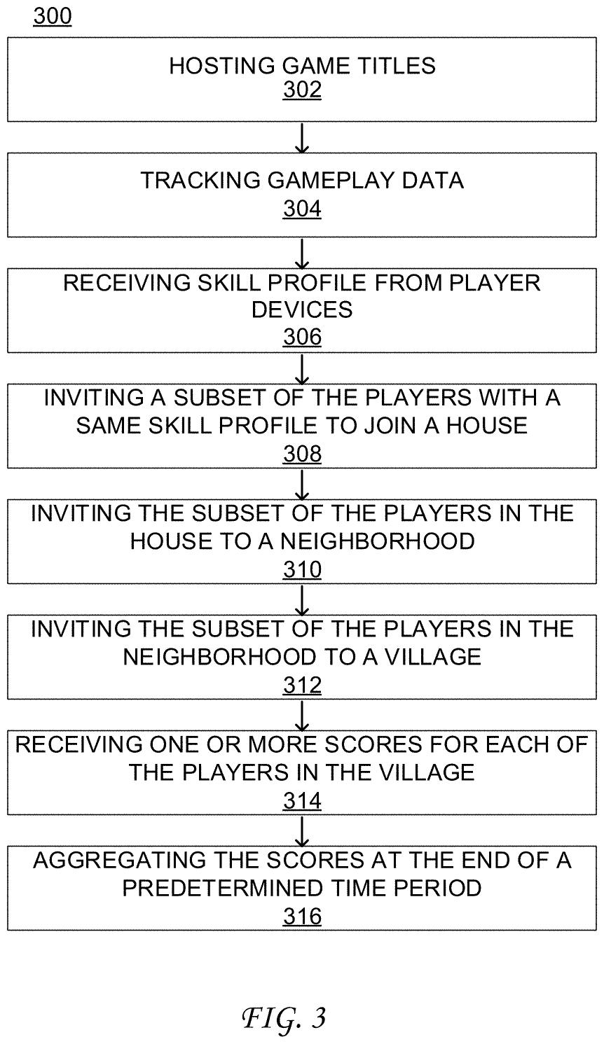

FIG. 3 illustrates a method 300 for providing cross skill competition. The methods 300 of FIG. 3 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 3 (and the order thereof) are exemplary and may include various alternatives, equivalents, or derivations thereof including but not limited to the order of execution of the same.

At step 302, a plurality of game titles is hosted on the gaming network 104. At step 304, a skill profile from one or more player devices associated with one or more players is received by the competition server 112. The skill profile includes one or more supported skills. At step 306, real-time gameplay data involving the plurality of game titles is tracked by the competition server 112. At step 308, a subset of the players with a same skill profile are invited by the competition server 112 to join a house. At step 310, the subset of the players in the house are invited to join a neighborhood. The neighborhood includes one or more houses with unique skill sets. At step 312, the subset of the players in the neighborhood are invited to a village. The village competes against other villages with a same skill set. At step 314, one or more scores is received by the competition server 112 for each of the players in the village. At step 316, the scores for each of the players in the village at the end of a predetermined time period are aggregated. The aggregate score of the village equally combines the scores of each house.

The scores are based on skill subdivisions, such as national organizations or major/minor league divisions. A village may compete with another village when all skill and skill subdivisions match between villages. In an example, a village with major and minor league baseball houses competes against other villages with major and minor league baseball houses. For example, in various aspects the village members may include professional sports teams selected or adopted by one or more user. As such, the villages may include competitions based upon the performance of professional sports. In one example, a village may select the New York Yankees, while in another village may select the St. Louis Cardinals, both of which are professional baseball teams in Major Leagues Baseball. Video games generally do not have a fixed schedule so gameplay and scoring may happen at any time. Athletic leagues often have fixed schedules and do not allow play at any time. Village competition is house-to-house or skill subdivision against skill subdivision, such that any village that has at least one house that has had play during a week will continue to score and will not be at a disadvantage versus any other village it plays against. In the examples where villages include professional sports teams, the performances of the professional team on a weekly, monthly, or even season long period may be evaluated. The corresponding scores or other statistics evaluated during the period may be determined and added to each respective village.

A player in a village may assume the role of “mayor” for a village. The mayor may request a minimum skill level. The mayor of a village is in charge of sending invitations to houses and/or neighborhoods anywhere to join the village. Mayors may be in as many villages as desired, but must remain active in each village. If the mayor or any other player in a village is not active, the house they are in is dropped from scoring. One or more other players in the village may nominate a replacement for the mayor. One or more other players in the village may nominate a replacement for another player.

FIG. 4 is an exemplary user device 400. User device 400 (e.g., desktop, laptop, tablet, mobile device, console gaming system) is a device that the user can utilize to facilitate carrying out features of the present disclosure pertaining to the viewing of third party content.

The user device 400 may include various elements as illustrated in FIG. 4. It should be noted that the elements are exemplary and that other aspects may incorporate more or less than the elements illustrated. With reference to FIG. 4, the user device 400 includes a main memory 402, a central processing unit (CPU) 404, at least one vector unit 406, a graphics processing unit 408, an input/output (I/O) processor 410, an I/O processor memory 412, a controller interface 414, a memory card 416, a Universal Serial Bus (USB) interface 418, and an IEEE 1394 interface 420, an auxiliary (AUX) interface 422 for connecting a tracking device 424, although other bus standards and interfaces may be utilized. The user device 400 further includes an operating system read-only memory (OS ROM) 426, a sound processing unit 428, an optical disc control unit 430, and a hard disc drive 432, which are connected via a bus 434 to the I/O processor 410. The user device 400 further includes at least one tracking device 424.

The tracking device 424 may be a camera, which includes eye-tracking capabilities. The camera may be integrated into or attached as a peripheral device to user device 400. In typical eye-tracking devices, infrared non-collimated light is reflected from the eye and sensed by a camera or optical sensor. The information is then analyzed to extract eye rotation from changes in reflections. Camera-based trackers focus on one or both eyes and record their movement as the viewer looks at some type of stimulus. Camera-based eye trackers use the center of the pupil and light to create corneal reflections (CRs). The vector between the pupil center and the CR can be used to compute the point of regard on surface or the gaze direction. A simple calibration procedure of the viewer is usually needed before using the eye tracker.

Alternatively, more sensitive trackers use reflections from the front of the cornea and that back of the lens of the eye as features to track over time. Even more sensitive trackers image features from inside the eye, including retinal blood vessels, and follow these features as the eye rotates.

Most eye tracking devices use a sampling rate of at least 30 Hz, although 50/60 Hz is most common. Some tracking devises run as high as 1250 Hz, which is needed to capture detail of very rapid eye movement.

A range camera may instead be used with the present disclosure to capture gestures made by the user and is capable of facial recognition. A range camera is typically used to capture and interpret specific gestures, which allows a hands-free control of an entertainment system. This technology may use an infrared projector, a camera, a depth sensor, and a microchip to track the movement of objects and individuals in three dimensions. This user device may also employ a variant of image-based three-dimensional reconstruction.

The tracking device 424 may include a microphone integrated into or attached as a peripheral device to user device 400 that captures voice data. The microphone may conduct acoustic source localization and/or ambient noise suppression.

Alternatively, tracking device 424 may be the controller of the user device 400. The controller may use a combination of built-in accelerometers and infrared detection to sense its position in 3D space when pointed at the LEDs in a sensor nearby, attached to, or integrated into the console of the entertainment system. This design allows users to control functionalities of the user device 400 with physical gestures as well as button-presses. The controller connects to the user device 400 using wireless technology that allows data exchange over short distances (e.g., 30 feet). The controller may additionally include a “rumble” feature (i.e., a shaking of the controller during certain points in the game) and/or an internal speaker.

The controller may additionally or alternatively be designed to capture biometric readings using sensors in the remote to record data including, for example, skin moisture, heart rhythm, and muscle movement.

As noted above, the user device 400 may be an electronic gaming console. Alternatively, the user device 400 may be implemented as a general-purpose computer, a set-top box, or a hand-held gaming device. Further, similar user devices may contain more or less operating components.

CPU 404, vector unit 406, graphics processing unit 408, and I/O processor 410 communicate via system bus 436. Further, the CPU 404 communicates with the main memory 402 via a dedicated bus 438, while the vector unit 406 and the graphics processing unit 408 may communicate through a dedicated bus 440. The CPU 404 executes programs stored in the OS ROM 426 and the main memory 402. The main memory 402 may contain pre-stored programs and programs transferred through the I/O Processor 410 from a CD-ROM, DVD-ROM, or other optical disc (not shown) using the optical disc control unit 430. The I/O processor 410 primarily controls data exchanges between the various devices of the user device 400 including the CPU 404, the vector unit 406, the graphics processing unit 408, and the controller interface 414.

The graphics processing unit 408 executes graphics instructions received from the CPU 404 and the vector unit 406 to produce images for display on a display device (not shown). For example, the vector unit 406 may transform objects from three-dimensional coordinates to two-dimensional coordinates, and send the two-dimensional coordinates to the graphics processing unit 408. Furthermore, the sound processing unit 430 executes instructions to produce sound signals that are outputted to an audio device such as speakers (not shown).

A user of the user device 400 provides instructions via the controller interface 414 to the CPU 404. For example, the user may instruct the CPU 404 to store certain information on the memory card 416 or instruct the user device 400 to perform some specified action.

Other devices may be connected to the user device 400 via the USB interface 418, the IEEE 1394 interface 420, and the AUX interface 422. Specifically, a tracking device 424, including a camera or a sensor may be connected to the user device 400 via the AUX interface 422, while a controller may be connected via the USB interface 418.

The present disclosure may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

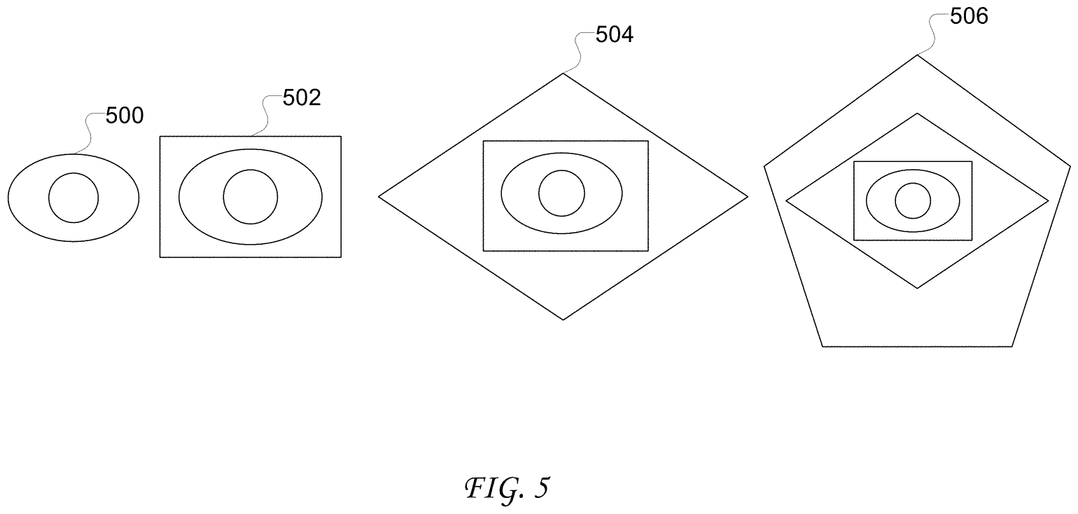

FIG. 5 is a diagram illustrating the structure of the house, neighborhood, and village. Players may create a personal profile and a skill profile(s) 500 for sport(s) and/or game(s). The skill profile 500 may be joined to a house 502, with up to a predetermined number of residents, all with the same skill profiles 500. Houses 502 may be joined into a neighborhood 504 of houses 502, with each house 502 having a unique skill set, so that in a neighborhood 504, players of different skills may combine their scores together. A house 502 may have optional performance criteria set by the user. A number of houses 502, either individually or as part of neighborhoods 504, may be joined into one village 506. A neighborhood 504 may have optional performance criteria and an optional charity may be set by the user. A village 506 only competes against other villages 506 that have the same skill set.

The following are examples of how the houses, neighborhoods, and villages may be organized by users. The following assumes personal profiles and skill profiles in one skill for the players. In an example, the server may create a house, a neighborhood, and a village for one player and invite no other players. In an example, the server may create a house and invite trusted experts in the skill and create a single neighborhood in a village. In an example, teams from Premier, Championship, League One, League Two, and National League houses each represent a real team, in one neighborhood in a village. Each house in the village competes with houses of the same division in other villages that have the same five houses. In an example, a single neighborhood with a house representing a Major League Baseball team and a house with one or more game players. In an example, villages are composed of one to five teams, randomly chosen. In an example, multiple groupings of activities and sports from one school may compete intramurally or against other schools.

The foregoing detailed description of the technology has been presented for purposes of illustration and description. It is not intended to be exhaustive or to limit the technology to the precise form disclosed. Many modifications and variations are possible in light of the above teaching. The described aspects were chosen in order to best explain the principles of the technology, its practical application, and to enable others skilled in the art to utilize the technology in various aspects and with various modifications as are suited to the particular use contemplated. It is intended that the scope of the technology be defined by the claim.

What is claimed is:

1. A system for cross skill competition, the system comprising:
at least one game network server that hosts a plurality of game titles and tracks real-time gameplay data involving the plurality of game titles; and
at least one competition server that:
receives a skill profile from one or more player devices associated with one or more players, the skill profile including one or more supported skills,
invites a subset of the players with a same skill profile to join a house,
invites the subset of the players in the house to a neighborhood, wherein the neighborhood includes one or more houses with unique skill sets,
invites the subset of the players in the neighborhood to a village, wherein the village competes against other villages with a same skill set,
receives one or more scores for each of the players in the village, and
aggregates the scores for each of the players in the village at an end of a predetermined time period.

2. The system of claim 1, wherein the competition server further displays the aggregate scores, via an interface associated with the player devices.

3. The system of claim 2, wherein the competition server displays the aggregate scores on a daily, weekly, or monthly basis.

4. The system of claim 1, wherein the competition server further receives a request from a player in the village to be a mayor of the village.

5. The system of claim 4, wherein the mayor requests a minimum skill level for the village.

6. The system of claim 1, wherein the skill profile further includes a motto.

7. The system of claim 1, wherein the skill profile further includes a charity.

8. The system of claim 1, wherein the competition server further:
receives a request from a second subset of players; and
allows the second subset of players to track a progress level of the neighborhood.

9. The system of claim 1, wherein the neighborhood has a predefined number of houses.

10. A method for cross skill competition, the method comprising:
hosting a plurality of game titles;
tracking real-time gameplay data involving the plurality of game titles;
receiving a skill profile from one or more player devices associated with one or more players, the skill profile including one or more supported skills;
inviting a subset of the players with a same skill profile to join a house;
inviting the subset of the players in the house to a neighborhood, wherein the neighborhood includes one or more houses with unique skill sets;
inviting the subset of the players in the neighborhood to a village, wherein the village competes against other villages with a same skill set;
receiving one or more scores for each of the players in the village; and
aggregating the scores for each of the players in the village at an end of a predetermined time period.

11. The method of claim 10, further comprising displaying the aggregate scores, via an interface associated with the player devices.

12. The method of claim 11, wherein displaying the aggregate scores occurs on a daily, weekly, or monthly basis.

13. The method of claim 10, further comprising receiving a request from a player in the village to be a mayor of the village.

14. The method of claim 13, wherein the mayor requests a minimum skill level for the village.

15. The method of claim 10, wherein the skill profile further includes a motto.

16. The method of claim 10, wherein the skill profile further includes a charity.

17. The method of claim 10, further comprising:
receiving a request from a second subset of players; and
allowing the second subset of players to track a progress level of the neighborhood.

18. The method of claim 10, wherein the neighborhood has a predefined number of houses.

19. A non-transitory computer-readable storage medium, having embodied thereon a program executable by a processor to perform a method for cross skill competition, the method comprising:
hosting a plurality of game titles;
tracking real-time gameplay data involving the plurality of game titles;
receiving a skill profile from one or more player devices associated with one or more players, the skill profile including one or more supported skills;
inviting a subset of the players with a same skill profile to join a house;
inviting the subset of the players in the house to a neighborhood, wherein the neighborhood includes one or more houses with unique skill sets;
inviting the subset of the players in the neighborhood to a village, wherein the village competes against other villages with a same skill set;
receiving one or more scores for each of the players in the village; and
aggregating the scores for each of the players in the village at an end of a predetermined time period.
